(19) United States
(12) Patent Application Publication
(10) Pub. No.: US 2003/0042324 A1
(43) Pub. Date: Mar. 6, 2003

(54) Drinking straw

(75) Inventor: Ka Ping Ho, Kowloon (HK)

Correspondence Address: SUGHRUE, MION, ZINN, MACPEAK & SEAS, PLLC, 2100 Pennsylvania Avenue, N.W., Washington, DC, 20037-3213, US

(73) Assignee: PARTY PRODUCTS MANUFACTURING LIMITED

(21) Appl. No.: 09/944,093

(22) Filed: Sep. 4, 2001

(51) Int. Cl. A61J 15/00

(52) U.S. Cl. 239/33

(57) ABSTRACT

The invention comprises in a drinking straw (1) formed by an elongated member open at each end. An object (5) is positioned in the straw and a pair of stops are provided forming a compartment (6) there between. The object is positioned between the stops within the compartment, and is dimensioned to substantially prevent movement of the object past the stops. Each stop however allows fluid to pass there by.

This invention relates to a drinking straw.

### BACKGROUND OF THE INVENTION

Novelty drinking straws have been provided but these usually comprise constructions in which the straws are twisted into one of a variety of possible shapes. Other novelty drinking straws may comprise drinking straws in which the straw is wound around an object which may subsequently be removed as desired. It is believed that there is a need for further alternative novelty drinking straws.

### OBJECT OF THE INVENTION

It is therefore an object of the present invention to provide a drinking straw which will go at least someway towards meeting the foregoing desiderata in a simple yet effective manner or which will at least provide the public with a useful choice.

### STATEMENT OF THE INVENTION

Accordingly the invention consists in a drinking straw comprising an elongated member open at each end, an object in the straw and a pair of stops forming a compartment there between, the object being positioned between the stops within the compartment, and being dimensioned to substantially prevent movement of the object past the stops, each stop however allowing fluid to pass there by.

Preferably the object is a decorative object.

Preferably each stop comprises one of, a concavity in the wall of the straw, an inward swaging of the wall of the straw, and a narrowing of the transverse diameter of the straw.

Preferably the density of the object is such that the object will float in the liquid intended to be drawn through the straw.

Preferably the object is insoluble in the liquid intended to be drawn through the straw.

Alternatively the object is soluble in the liquid intended to be drawn through the straw.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will be described with reference to the accompanying drawings in which,

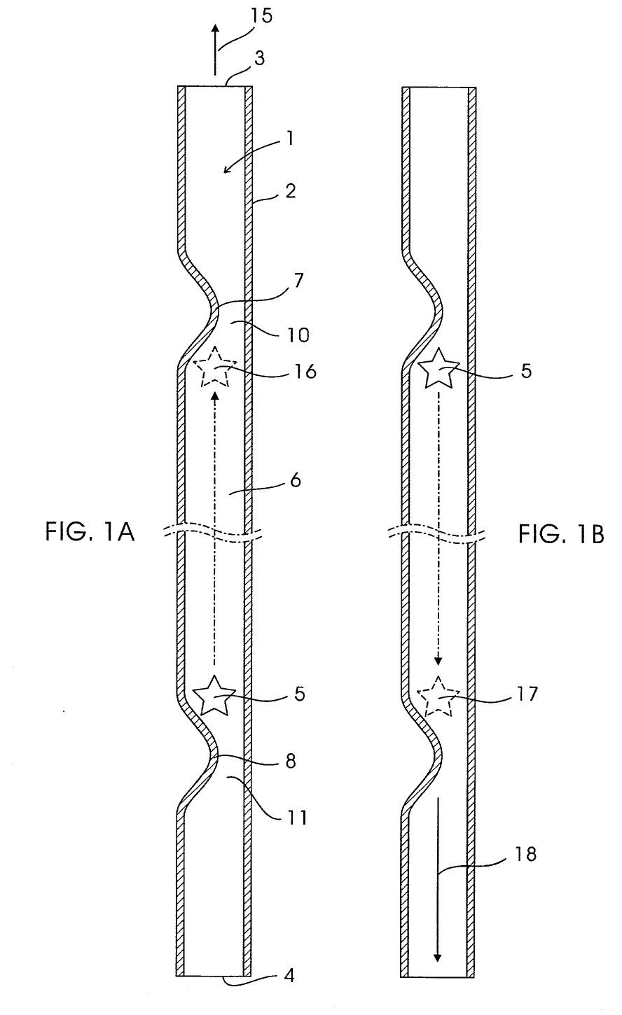

FIGS. 1A and 1B show one preferred form of the invention,

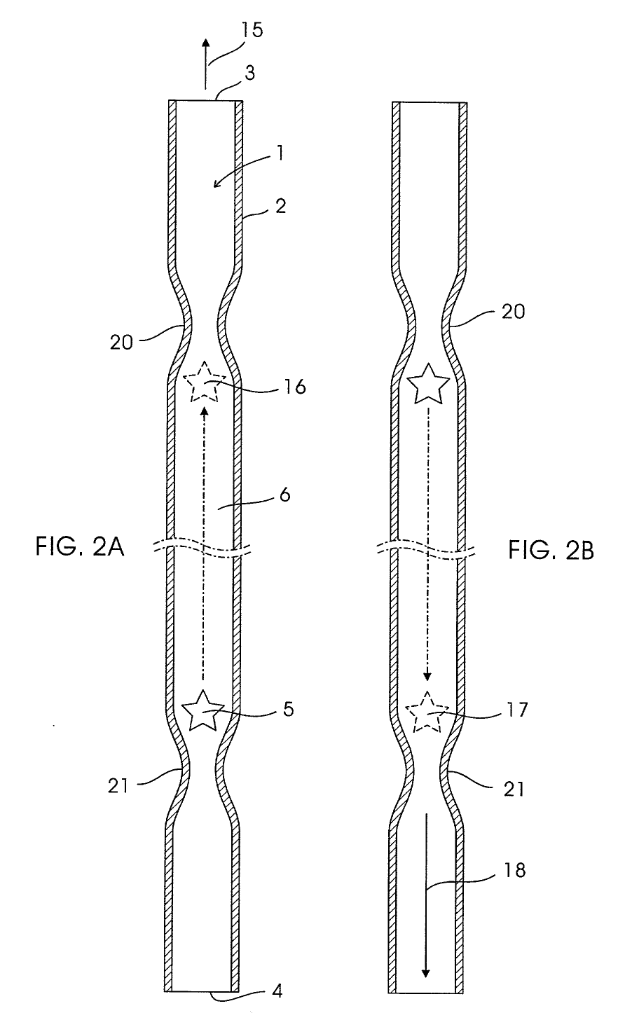

FIGS. 2A and 2B are cross sectional views of a drinking straw in an alternative preferred form of the invention, and

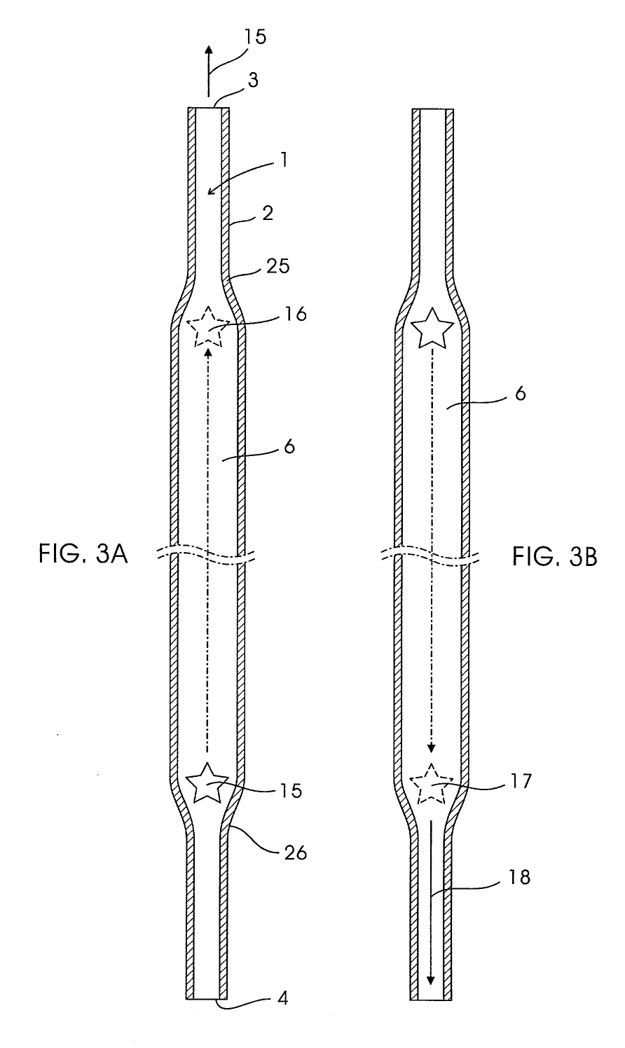

FIGS. 3A and 3B are cross sectional views of a still further alternative embodiment of the invention.

Referring to the drawings in FIG. 1A and 1B a drinking straw 1 is shown having a wall 2. The straw is open at each end 3 and 4 and maybe of any desired length.

An object 5 is provided in the straw. In order to constrain the movement of the object 5 a pair of stops are provided defining a compartment 6 there between. In the construction of FIGS. 1A and 1 B the stops are provided by an inward concavity 7 spaced apart from an inward concavity 8 so that the compartment 6 is defined between the inward concavities 7 and 8 in the wall 2 of the straw. The dimension of the object 5 is such that it will freely move in the compartment 6 but will not pass the stops 7 and 8. However as will be apparent from the drawing neither the stops nor the object 5 completely close the drinking straw so that spaces 10 and 11 are provided between the concavities 7 and 8 and the opposite parts of the wall so that liquid drawn through the straw will pass the stops and the object.

The object 5 is formed from a material which is non-toxic to a person using the straw and may either be insoluble in the liquid intended to be drunk through the straw or provided care is taken could as an alternative be soluble. Of course if it is soluble the object must dissolve quickly to avoid a partly dissolved object passing through the mouth of the user in a dangerous fashion.

Referring to FIG. 1A if the end 4 of the drinking straw 1 is inserted into a liquid to be drunk and the end 3 is sucked in the usual manner liquid in the straw will move in the direction of arrow 15. The object 5 will be drawn by the sucking movement into the position 16 where it is prevented from further movement by the stop 7. When sucking on the straw ceases the object 5 will fall back to the position 17 in FIG. 1B as the liquid drains in the direction 18.

The object 5 can be of a density such that it floats or alternatively does not float within the liquid intended to be drunk through the straw. The construction shown in FIGS. 2A and 2B is substantially similar save that the stops are formed by inward swaging of the wall 2 of the drinking straw for example at positions 20 and 21 so that again the object 5 is prevented from passing the stops so formed.

The construction of FIGS. 3A and 3B again is somewhat similar save that the stops are formed by a narrowing of the tube wall 2 at the positions 25 and 26 to again form a stop substantially in the same manner.

In use as has been described above when an outward pressure is applied at end 3 of the drinking straw 1 for example by means of sucking that end the object 15 will be drawn to the upper stop 7, 20 or 25 and when the sucking pressure is removed the downward flow of the fluid will return the object to the position 17. Thus it can be seen that a drinking straw is provided which has a substantial novelty effect in the movement of an object within the straw. As has been described above the object can take one of a variety of possible forms and can float or not float, dissolve or not dissolve as desired in the liquid of course it is possible to make the object of material that is reflective or otherwise will catch attention.

1. A drinking straw comprising an elongated member open at each end, an object in the straw and a pair of stops forming a compartment there between, the object being positioned between the stops within the compartment, and being dimensioned to substantially prevent movement of the object past the stops, each stop however allowing fluid to pass there by.

2. A drinking straw as claimed in claim 1 wherein the object is a decorative object.

3. A drinking straw as claimed in claim 1 wherein each stop comprises one of, a concavity in the wall of the straw, an inward swaging of the wall of the straw, and a narrowing of the transverse diameter of the straw.

4. A drinking straw as claimed in claim 1 wherein the density of the object is such that the object will float in the liquid intended to be drawn through the straw.

5. A drinking straw as claimed in claim 1 wherein the object is insoluble in the liquid intended to be drawn through the straw.

6. A drinking straw as claimed in claim 1 wherein the object is soluble in the liquid intended to be drawn through the straw.
